(19) United States
(12) Patent Application Publication
(10) Pub. No.: US 2017/0072316 A1
(43) Pub. Date: Mar. 16, 2017

(54) SYSTEM AND METHOD FOR PROVIDING AN ALTERNATE REALITY RIDE EXPERIENCE

(71) Applicant: Astral Vision Ltd., Ramat Gan (IL)

(72) Inventor: Guy FINFTER, Ramat-Gan (IL)

(21) Appl. No.: 15/310,109

(22) PCT Filed: Nov. 16, 2015
(86) PCT No.: PCT/IB15/58835

§ 371 Date: Nov. 10, 2016

Related U.S. Application Data
(60) Provisional application No. 62/080,325, filed on Nov. 16, 2014.

(51) Int. Cl. A63F 13/573; A63F 13/428; A63F 13/28; A63F 13/212; A63F 13/26

(52) U.S. Cl. CPC A63F 13/573; A63F 13/212; A63F 13/26; A63F 13/28; A63F 13/428

(57) ABSTRACT

This invention relates to a wearable autonomous apparatus adapted to altering at least one or more user's senses, such as views, sound, smell, or haptic/tactile, of an alternate reality scene in response to a real physical movement of the user.

### CROSS-REFERENCE TO RELATED APPLICATIONS

This application claims the benefit of provisional patent application (PPA) Ser. No. 62/080,325, filed Nov. 16, 2014 by the present inventors, which is incorporated by reference in its entirety herein.

### FIELD OF THE INVENTION

The present invention relates generally to displays, and particularly to a system providing alternate reality to a user.

### BACKGROUND OF THE INVENTION

Moving objects such as amusement rides, amusement carousel, trains, cars, subways buses, automobiles, and airplanes: they all produce motion, the basis of their own operations. Each of these mechanized sources, relative to its own transportation application, might travel in a known track. Each vehicle mechanism, regardless of its configuration, produces its own type of movement.

Vehicle-based rides, such as miler coasters, typically consist of a known course (such as a track or waterway) and a vehicle. Such rides are mechanically simple, reliable, and treat riders to the sensations associated with high speeds, loops, rolls, and sustained G-forces.

The excitement which amusement rides create on the riders (i.e., the combination of a ride along a track the G-forces produced on the riders as the car undergoes angular, elevation and speed changes, and the scenery which a ride passes through) have made amusement rides an important attraction of every amusement park and the most influential to the park's business.

Because amusement rides are important to a park's business, the need for periodically providing new rides becomes more important for the parks development. However, the costs required for any renewals, upgrades or remodeling of such rides, including the costs for laying new tracks and/or constructing new landscape, are usually high, especially when any such changes must usually involve safety concerns which make the renewals, upgrades and remodeling more costly.

Another problem is that even in a case that a miler coaster is supplying enough excitement to the riders; the riders still get to see the same views repeatedly, which might cause the riders to lose interest quickly.

### SUMMARY OF THE INVENTION

According to the teachings of the present embodiment there is provided a method for providing alternate reality to a user, including: providing a ride map describing a path of the user through physical space; providing an alternate reality file containing data sufficient for implementing a given alternate reality; providing a physical location of the user, providing gaze data of the user; determining a current location of the user in the ride map based on the ride map and the provided physical location; and calculating a reference, the calculating based on the current location of the user in the ride map, the provided gaze data, and the alternate reality, the reference indicating which parts of the alternate reality to provide to the user, wherein the physical location is provided based on sensors worn by the user.

In an optional embodiment, the physical location of the user is specific to the user and not to a vehicle of the user. In another optional embodiment, the physical location of the user is provided only using sensors worn by the user. In another optional embodiment, the sensors are of a bead mounted device (HMD) worn by the user. In another optional embodiment, a portion of the sensors are of a head mounted device (HMD) worn by the user and another portion of the sensors are of a wearable add-on worn by the user. In another optional embodiment providing a portion of the alternate reality to the user is based on the reference. In another optional embodiment, the user is moving on a track, the track being a physical structure used for a known path of movement, and the determining a current location of the user is synchronized to the user's movement on the track. In another optional embodiment, the ride map is an individual ride map based on the user's location in a moving vehicle on a path relative to a track. In another optional embodiment, the ride map is a multi-layer map being a combination of time-based and space-based data describing the user's movement through physical space.

According to the teachings of the present embodiment there is provided a system for providing alternate reality to a user, including one or more sensors worn by the user; and a processing system containing one or more processors, the processing system being configured to: receive a ride map describing a path of the user through physical space; receive an alternate reality file containing data sufficient for implementing a given alternate reality, receive sensor data from the one or more sensors worn by the user, derive a physical location of the user based on the sensor data; receive gaze data of the user, determine a current location of the user in the ride map based on the ride map and the physical location; and calculate a reference, the calculating based on the current location of the user in the ride map, the gaze data, and the alternate reality, the reference indicating which parts of the alternate reality to provide to the user.

In an optional embodiment, the processing system is worn by the user. In another optional embodiment, the gaze data is provided by a head mounted display (HMD) worn by the user. In another optional embodiment, the physical location of the user is specific to the user and not to a vehicle of the user. In another optional embodiment, the physical location of the user is provided only using sensors worn by the user. In another optional embodiment, the sensors are configure in a head mounted device (HMD) worn by the user. In another optional embodiment, a portion of the sensors are configured in a bead mounted device (HMD) worn by the user and another portion of the sensors are configured as wearable add-ons worn by the user. In another optional embodiment, the processing system is further configured to provide a portion of the alternate reality to the user based on the reference. In another optional embodiment, the user is moving on a track, the track being a physical structure used for a known path of movement, and the determining a current location of the user is synchronized to the user's movement on the track. In another optional embodiment, the ride map is an individual ride map based on the user's location in a moving vehicle on a path relative to a track. In another optional embodiment, the ride map is a multi-layer map being a combination of time-based and space-based data describing the user's movement through physical space. In another optional embodiment, the user is a rider on a roller coaster and an HMD is secured to the user's head via a dual-strap configuration including at least one strap under the user's chin and at least one strap over the user's head.

In an optional embodiment, the alternate reality is provided to a user via a head mounted display (HMD).

According to the teachings of the present embodiment there is provided a non-transitory computer-readable storage medium having embedded thereon computer-readable code for providing alternate reality to a user, the computer-readable code including, program code for: providing a ride map describing a path of the user through physical space; providing an alternate reality file containing data sufficient for implementing a given alternate reality; providing a physical location of the user; providing gaze data of the user; determining a current location of the user in the ride map based on the ride map and the provided physical location; and calculating a reference, the calculating based on the current location of the user in the ride map, the provided gaze data, and the alternate reality, the reference indicating which parts of the alternate reality to provide to the user, wherein the physical location is provided based on sensors worn by the user.

According to the teachings of the present embodiment there is provided a computer program that can be loaded onto a client connected through a network to a server computer, so that the client running the computer program constitutes a processing system in a system according to any one of the embodiments.

### BRIEF DESCRIPTION OF FIGURES

The embodiment is herein described, by way of example only, with reference to the accompanying drawings, wherein:

FIG. 1A is a sketch of an HMD for the current embodiment in an open configuration.

FIG. 1B is a sketch of an HMD for the current embodiment in a closed (operational) configuration.

FIG. 2 is a detail of system modules.

FIGS. 3A to 3D are graphs of acceleration-duration limits.

FIG. 4 is a sketch of a method to create and display an alternate reality.

FIG. 5 is a flowchart of a method to synchronize alternate and real environments.

FIG. 6 a sketch of dividing a physical map into separate sections.

FIG. 7A is a high-level sketch of the major components of the system.

FIG. 7B is a high-level diagram of configuration and deployment of system modules.

FIG. 8 is a high-level partial block diagram of an exemplary system configured to implement the processing module of the present invention

### DETAILED DESCRIPTION

The principles and operation of the system and method according to a present embodiment may be better understood with reference to the drawings and the accompanying description. A present invention is a system for providing to a user alternate reality simulations during a tide on a moving object.

A preferred embodiment of using the system is by a rider on a roller coaster, but embodiments can be applied to any moving object traveling along a known path. For simplicity and clarity in this document, the general mechanized moving object source example is a roller coaster ride at a theme park. Based on this description, one skilled in the art will be able to implement embodiments for other environments, including but not limited to moving objects on relatively fixed paths or other moving objects (not traveling along a known path). For example, riders in a car, such as kids in the back seat can be fed general stories based on car movements. In a case where the known road-trip (physical ride map, individual ride map) of a car can be obtained from (based on) the vehicle GPS through an in-vehicle network, then the system knows the planned road-trip with destination and route, and can plan a corresponding alternate reality environment for the riders (kids). In this case, the physical ride map is general, or rough, plus or minus an amount depending on the mode of travel. In a case where the trip (physical ride map) is not known (unknown), the system used feedback from the system's sensors to determine user movement and present a more generalized alternate reality environment. In another example, the system can also be used without a moving vehicle, for example with a person walking. In this case, care should be taken for the safety of the user in traversing the user's environment, such as providing safe boundaries for the user.

In the context of this document, the system is also referred to as the “HMD system” as the HMD (head mounted device/display) is one of the primary components of the system.

The terms “user” and “rider” are generally used interchangeably. In the current description, references to a rider or user of the HMD are also referred to as simply the user or the HMD, unless otherwise specified. References to the user include one or more portions of the user, such as the user's body, head, arm, etc. as will be obvious from context.

The terms “alternate environment”, “alternate reality”, “alternate reality scene”, “scene”, “virtual environment” and “virtual world” are used similarly and use will be apparent from context.

“Physical space” is space in the real world, as opposed to “virtual space” in which the alternate reality occurs, typically 3D, but can also be 2D as appropriate to the specific application.

Correspondingly, “physical location” is an actual, real location in physical space in comparison to “virtual location” that is a computed location in virtual space (such as the virtual location of a rider in an alternate reality).

“Real movement” or “physical movement” generally refers to movement in physical space (such as a rider on a moving roller coaster) while “virtual movement” refers to movement in virtual space (such as warrior flying a space ship. The real movement of the rider (on the roller coaster) is synchronized with the virtual movement of the (rider as) warrior to provide (present) the alternate reality of the warrior flying a spaceship.

In the context of this document, the term “track” is generally used to refer to a physical structure used for movement. Tracks are typically fixed, permanent structures such as roller coaster rails or amusement carousel platform, and also include street lanes on which a car drives or corridor along which a person walks. Correspondingly, a “physical map”, also referred to as a “physical ride map” or “travel course” is a map of the track.

Similar to a “track” corresponding to a physical structure, the term “path” corresponds to a logical movement. Typically, a track will have a corresponding path. The path can be the logical or actual movement of an object (typically a user) in reference to the physical track. Note that different objects traveling the same track may have different paths, for example, a car vs. a person traveling along a road. Another example is two roller-coaster seats—each travels the same track, but is in a different location relative to the track, so will have a different path.

In general, a “ride map” is a description of a path, or path of an object, through physical space. A ride map can be viewed as the logical movement of an object (such as a roller-coaster car) based on a physical structure used for movement (such as a roller-coaster track). A ride map typically includes additional information, for example sections and checkpoints (described below). An “individual ride map” is a ride map for a specific location in reference to the track, for example, a specific seat in a specific car in relation to a roller-coaster track.

In the context of this document, the terms “instantaneous”, “actual”, and “real-time” are used as generally known in the art, sufficiently fast so that a user does experience any noticeable delay

In recent years, vehicle-based rides have encountered competition from a new type of ride, which is essentially a modified flight simulator. Riders are seated within a boxlike capsule that is mounted on a hydraulically actuated motion base. The interior of the capsule includes an audio/visual system and the riders face the system's visual display. The motion signals for the base and audio/visual signals are recorded in synchronized fashion. When the motion, audio, and video signals are played back, movement of the capsule corresponds to the sights and sounds provided by the audio/visual system.

Simulators can provide audio/visual experiences that cannot be provided by conventional roller coasters or other moving object rides. In fact, simulators can provide a large combination of images and sounds.

In contrast to providing audio/video, the variety of motion sensations that can be provided by a conventional simulator is severely restricted due to the short range of movement possible with a mechanical motion base. So are the G-forces. This restricts the simulator's ability to provide a convincing experience. Another limitation associated with simulators used for amusement purposes is the fact that simulators typically carry up to 30 riders in order to produce enough revenue to offset the simulator's high cost. As a result, convincing riders that the riders are in a small space, such as that found in a sports car, the cockpit of a jet fighter, or a bobsled is difficult. In addition, due to the simulator's cost and resource requirements, there is a practical limit to how many distinct physical attractions of this level of sophistication any single theme park venue can support.

The current system is a system for enhancing and/or increasing the experience provided by real existed amusement rides, and the capability to change the ride's environment without having to incur expensive costs of remodeling and reconstruction. The system provides a combination of a digital alternate world generating system composed on a real physical riding path. As a result, the combination of the sensory richness and power of illusion produced by a computer alternate environment and the real movements caused by riding along the existing physical path of the roller coaster may provide an experience that seems more personal, more interactive, and more flexible in response to rider preferences, than are most existing theme park attractions.

Current techniques for providing a real and alternate environment combination are technologically complex, including synchronization methods requiring high precision of the riders' location, and modifications in current roller coaster infrastructure. In addition, current solutions require sensors, deployed on the track (including the starting ride point), and connected with the rider's vehicle. Such system needs to have a physical track or vehicle wheels for sensor's layout and cannot work on moving objects such as carousels, or people that walk which do not have (move independent of) a physical track or wheels. In addition, for applying the current solutions, there is a need to prepare a specific alternate world simulation for each roller coaster. Moreover, the current solutions do not provide an individual rider a full personal experience, as there is a single display for every vehicle and not for every rider, so the rider's personal direction of sight in the simulated environment is not considered.

The current system can be used to provide an amusement ride experience that is superior to techniques presently known in the art. In particular providing one or more apparatus associated with a rider (such as head mounted device, HMD or optical HMD) on a moving object aimed to increase ride's experience along a track, and adapted to provide the rider with at least one of audible, visual or smell sensations. This combination provides riders with “the best of both worlds,” i.e. the sensations associated with high speeds, low speeds, loops, rolls, floating and changing G-forces, as well as the simulated reality provided by conventional simulators. As a result, the present embodiment can more realistically simulate the sights, sounds smell and feelings associated with, for example, jet fighters, war ships or river rafts, as compared to conventional solutions.

### Features

The current embodiment can be implemented in compliance with strict safety criteria that enable the system to be used under conditions of rapid environmental physical changes, such as changing G-force, loops, sharp turns etc.

The system is an autonomous, easy to operate device that is fit to use with multiple riders, and easy to install so that no fundamental modifications of established roller coaster design and construction practices is required. As such, the system can be used or transferred freely upon demand for different ride facilities, reducing capital expenses for deployment, and operating and maintaining costs.

The system is self-contained, in that the system does not require instrumenting a rider's physical surrounding, such as the roller-coaster track, seat, wheels, or vehicle, for rider location detection or movement detection. In other words, the identification of any location/movement of the rider is made by the system (typically worn by the rider). This facilitates the rider getting a better personalized and more accurate alternate experience, where the rider is being located and not the vehicle in which the rider and other passengers are sitting together. In a case where the sensors are deployed in multiple parts, typically a first portion of the sensors are of a head mounted device (HMD) worn by the user and a second portion of the sensors are of one or more wearable add-ons worn by the user. The wearable add-ons can be deployed on various portions of the user, as appropriate. For example, sensors on the user's body, arm, hand, etc. providing location, movement, and feedback information on that portion of the user's body, such as arm motion, hand position, etc. As described elsewhere in this document, the second portion can be deployed, for example, on the rider's arm, or in the rider's seat. In this case, the term “worn” includes being deployed in the vicinity of the rider, preferably touching the rider. In other words, sufficiently near the rider so that sensor data reflects the rider's location with sufficient accuracy to calculate references to the alternate reality that correspond to the rider's location. The second portion is associated and/or correlated with the rider's location The deployment of the second portion is equivalent to being worn by the rider and can provide an actual location of the rider, in contrast to sensors on the car or track that provide a location of the car 17. The system that enables a rider to see any part of the alternate scenes from the rider's own point of view, regardless of where the other riders are observing, and at the same time as other rides. For example, a first rider can look to the first rider's right while at the same time a second rider sitting net to the first rider looks to the left. In this case, the two riders are able to see two different angles of the same alternate scene (each seeing a corresponding angle).

A method of the current embodiment produces an alternate environment that is suitable not only for a specific moving object, but includes generic rules and scenery that can be applied automatically to any moving object with the same type of movement (such as a roller coaster family).

The system includes using integrated wearable add-ons for interactivity with virtual objects in the alternate environment. For example, current conventional input devices such as keyboards or joysticks may be uncomfortable for a rider on a high-speed roller coaster, and may constitute a safety challenge in case these conventional input devices fall from the riders hands.

### System Overview

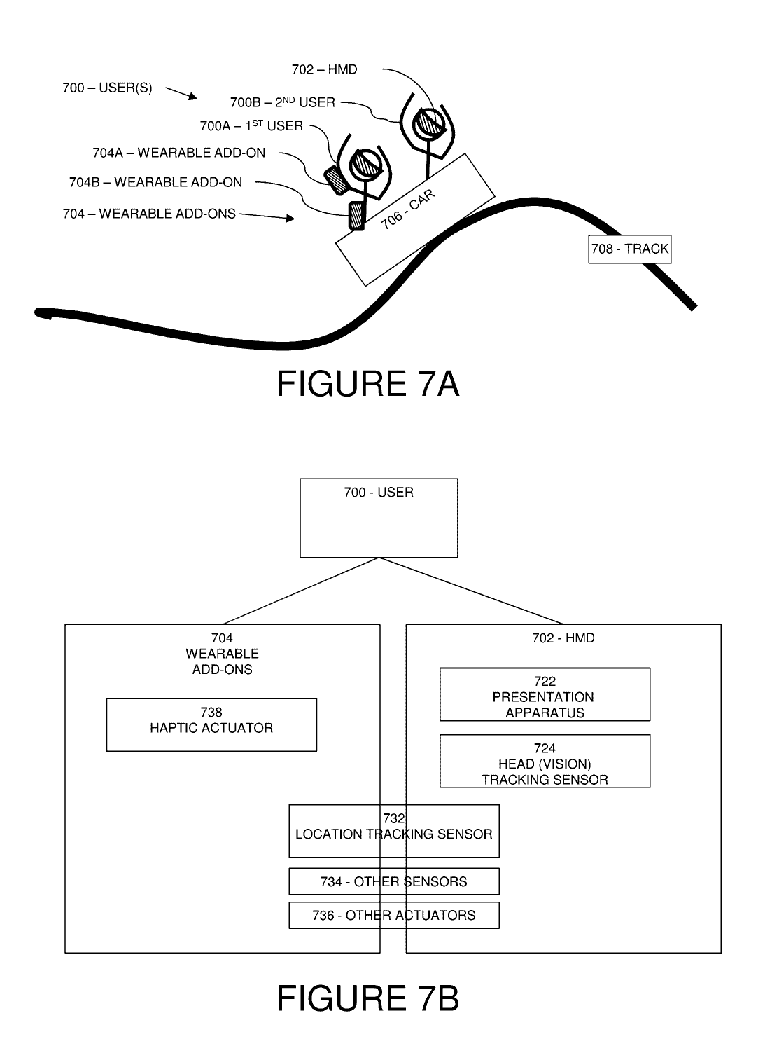

Referring now to the figures, FIG. 7A is a high-level sketch of the major components of the system. As noted above, preferred embodiment of using the system is by a rider on a roller coaster. One or more users 700, such as first user 700A and second user 700B ride in a oar 706 on a track 708. Each user has a head mounted device (HMD 702). Optionally, each user may have one or more wearable add-ons 704, such as wearable add-on 704A and 704B. As noted elsewhere in this document, the wearable add-ons 704 can be configured on the user or in proximity to the user, such as on or near the car seat of the user.

Refer now to FIG. 7B, a high-level diagram of configuration and deployment of system modules. A user 700 typically has an HMD 702 and optionally one or more wearable add-ons 704. The HMD 702 typically has a presentation apparatus 722 and one or more head (vision) tracking sensors 724. Optionally, the head (vision) tracking sensor 724 could be a wearable add-on 704 configured on the head separate from the HMD 702. In a case where the HMD 702 has an optical display, the HMD is known as an optical HMD (OHMD). The wearable add-ons 704 optionally have one or more sensors and/or actuators. For example, the wearable add-on 704 may have a haptic actuator 738 to provide haptic feedback to a user's 700 body. Both the HMD 702 and wearable add-on 704 can additionally and/or optionally be configured with sensors and actuators such as a location and tracking sensor 732 (providing location and tracking of the user in three- or two-dimensional (3D or 2D) space), other sensors 734, and other actuators 736. Connections between system modules (including sensors and actuators), in particular between the HMD 702 on the user's head and wearable add-ons 704 on or near the user's body, can be via wired or wireless technologies, as are known in the art.

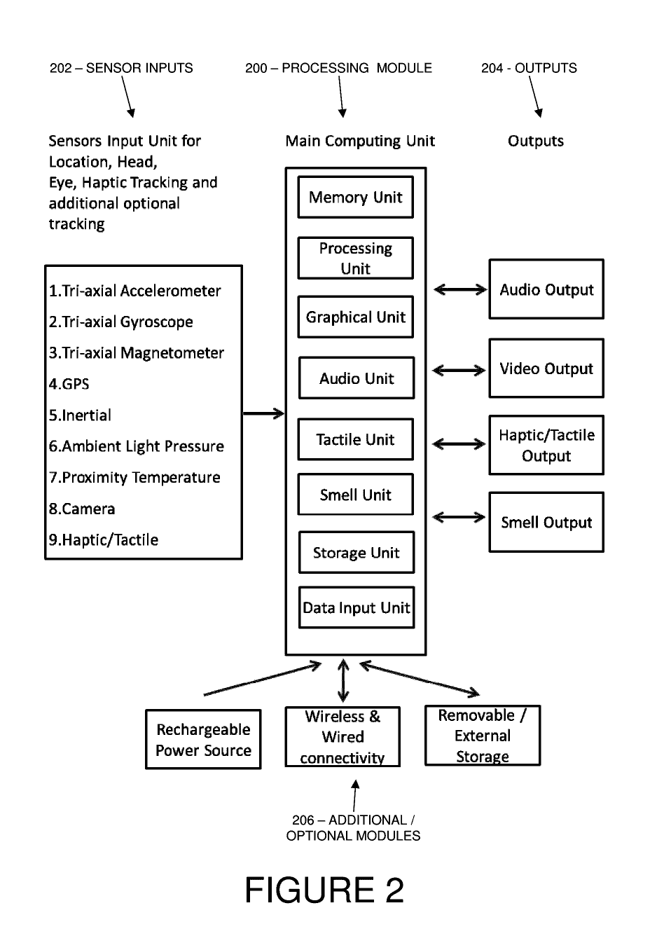

Refer now to FIG. 2, a detail of system modules. A processing unit (also referred to as a module or system) 200 includes one or more processors and sub modules including, but not limited to modules (units) such as memory unit, processing unit, graphical unit, audio unit, tactile unit, smell unit, storage unit, and data input unit. The processing module 200 can be implemented as a PC board (PCB), simply referred to as a “board”. The processing module 200 can be implemented as part of the HMD 702 or as a wearable add-on 704.

Input can come from sensors 202 including other sensors 734 configured in the HMD 702 or in one or more wearable add-ons 704. Sensors may be configured in or via a sensor input unit for providing sensing data including: user location, head location, eyes locations, gaze direction, haptic tracking, and additional tracking. Locations and directions can be provided in 3D, 2D, vector, and other formats, as applicable. Sensors include, but are not limited to tri-axial accelerometer, tri-axel gyroscope, tri-axial magnetometer, OPS, inertial, ambient light pressure, proximity temperature, camera, and haptic/tactile.

Output modules, such as outputs 204, can be configured in the HMD 702 or in one or more wearable add-ons 704. Outputs 204 include audio, video, haptic/tactile, and smell (scent). Additional and optional modules 206 include rechargeable power source, wireless and wired connectivity (communication modules), removable storage, and external storage. Outputs 204 can be configured in the HMD 702 or in one or more wearable add-ons 704.

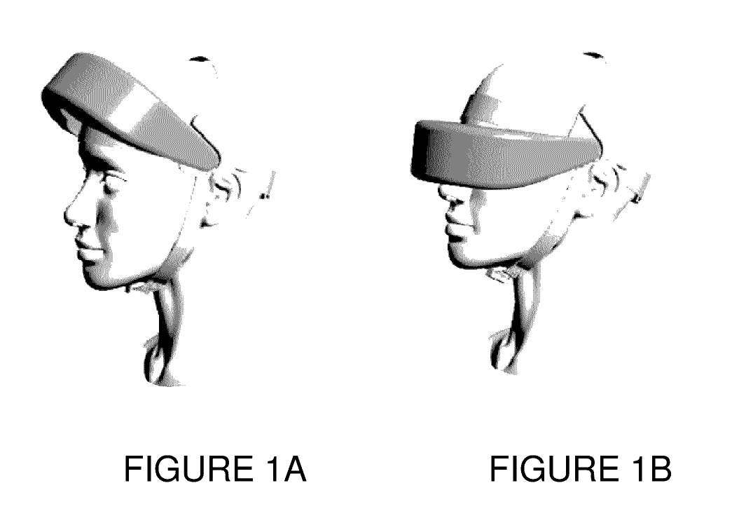

Refer now to FIG. 1A a sketch of an HMD for the current embodiment in an open configuration and FIG. 1B a sketch of an HMD for the current embodiment in a closed (operational) configuration. The presentation module, such as HMD 702 includes a visual presentation apparatus, for example where the HMD is an optical head mounted display (OHMD). The HMD includes an enclosure, straps, display, various outputs, and electronics. The base for the HMD can be, for example, an upgraded, modified version of the Oculus Rift DK2 (Menlo Park, Calif., United States) or Custom HMD of Sensics (using for example, the OSVR platform) (7125 Thomas Edison Dr #225, Columbia, Md. 21046, United States). The screens of the HMD display can opaque, half-transparent, or see-through displays, optical or video based, made for augmented reality presentation or for purpose of presenting the rider with the real environment when the ride ends or the ride is stopped. The screens of the HMD can also be a mixed-use technology (virtual and augmented reality display using the same display apparatus), or could have a clip-on to change states between AR and VR (such as used by CastAr technology, 380 Portage Ave., Palo Alto, Calif. 94306, USA).

A feature of the current embodiment is the basic HMD is configured with at least a dual strap configuration—at least one strap under the chin and at least one strap (or equivalent) over the head. Conventional HMDs are typically not suitable for use in the current system. Conventional HMDs are designed for a relatively small range of motion and forces, as opposed to implementations of the current embodiment. As described elsewhere in this document, a rider using the current system for a miler coaster is subject to forces such as accelerations, sudden turns or high gravitational forces not found in conventional uses of HMDs. Thus, an improved HMD configuration is required for operation and safety of the system.

Refer again to FIG. 7B, location-tracking sensors typically connect to the processing module 200 and are operable to detect physical characteristics associated with the instantaneous rider's location along a travel course. Head tracking sensors connect to the processing module 200 and being operable to detect physical characteristics associated with the instantaneous rider's direction of field of vision (such as, looking to the right or to the left). The sensors provide measurements such as, precise real-time 3D orientation, heading, calibrated acceleration, and calibrated angular velocity and may include 9-axis inertial measurement unit (IMU) and attitude heading reference system (AHRS). Sensors type could be Tri-axial Gyroscope, Tri-axial Accelerometer, Tri-axial Magnetometer, Ambient Light Sensor, Pressure Sensor, Proximity Sensor, Inertial Sensor, Temperature Sensor, GPS, Camera, etc. The sensors should be resistant to strong forces operated on the sensors such as gravity, negative gravity, or electromagnetic influences that might come from the riding environment.

Other devices that can be connected to the HMD include eye trackers, such as Sensics eye tracker, which measure the point of gaze, allowing the system to sense where the rider is looking. This information is useful in a variety of contexts such as vision research—understanding where a rider's attention is focused in a given scene, which can help to improve the alternate environment. Another use for eye tracker can be at rider interface navigation—by sensing the rider's gaze, the system can change the information displayed on a screen, and bring additional details into attention. Another use for eye tracker can be for safety—by sensing riders eye closing, for example, during the ride, the system can stop immediately the presentation, etc.

For best appearance of the display, the HMD is built in a way that most of the daylight does not reach the eyes of the rider during a virtual reality display. Since different riders have different face structure, the eye cover construction should be flexible and adjustable. This is achieved, for example, by putting a rubber or soft polymer as an eye cover frame coating.

The system has a memory (memory unit) being operable to store alternate reality stimuli information regarding the riding track (physical map), such as video, audio, and other sensory data such as smell and tactile. The memory is connected to a central processing part (processing module 200) being operable to select the alternate reality stimuli information corresponding to the position of the rider and the direction of the field of vision of the rider or other interactive movements of the rider. At least one speaker (typically at least 2) and at least one display are used to output the selected auditory and visual information, respectively.

The HMD is typically equipped with a power supply in order to prevent the need to make special modifications in the moving objects that does not always have available electrical socket next to the rider seat. The power supply could be batteries. For preventing heat burns, the power supply should avoid a direct contact with the rider's body. The power supply could be placed inside the HMD or inside or on top the surrounding HMD's straps or in a separate place, such as the hip or the arm of the rider (in general as a wearable add-on 704). For electrical charging, the power supply could be removed from the HMD or have a built in charging socket.

The individual can choose to revert to reality at any point along the track. This could be done, for example, by voice recognition, a simple ergonomically designed switch, eye tracker that detects a long eye closing, or with a magnetic lock at the eye cover frame that can be pushed up easily but is not weak enough for sudden opening during the ride (strong enough to resist sudden opening during the ride). Reverting options act as feedback to the process control to discontinue, or continue, the individual's alternate reality illusion. Some of the mentioned reverting options require the HMD to have half-transparent or see-through displays; others could have a display that is laid on an axis, such as the eye protecting cover of a motorcycle helmet.

While waiting in line and wearing the apparatus, closing the HMD eye cover could be dangerous since the rider will not see the real environment and might bump into other people standing in the line and fall down. The HMD might have the option to prevent the rider from closing the eye cover part unless the rider is sitting inside the moving object. This can be done, for example, by having an electronic or magnetic lock that keeps the eye cover open until the roller coaster operator unlocks the lock with a remote control or other device after all the riders are in place in the car and ready to go. Another way is, for example, by playing a special error noise if the rider is trying to close the eye cover before the right time or by displaying an error message on the HMD display asking the rider to open the eye cover.

The rider, the park owner, or the HMD operator has the option to choose the alternate reality to be presented at a specific ride. The specific alternate reality to be used (played) may be selected by downloading a corresponding alternate reality file to the system/HMD, or choosing an alternate reality from a number of options that are already downloaded and configured in the system. Downloaded files can be stored in the memory unit inside the HMD, in the processing module, or in additional modules such as remote, external, or removable storage. One skilled in the art will realize that alternate reality files can also be supplied via known means such as remote, external, or removable storage. The download process is preferably done via data cable or wireless data communication component installed inside the HMD. The selection of the alternate reality can be done by a mechanical switch built on the HMD or wireless data communication component that connects to an outside application installed on electronic device such as computer, tablet, or cell phone. Optionally, led bulbs located on the external part of the HMD, or other display screen indicates different states of the system, such as uploading errors, movies numbers, or any other relevant messages. The rider can enter a serial number of the HMD or scan a printed HMD barcode and the alternate reality simulation can be downloaded to the rider's own HMD (personally owned). The data collected throughout the HMD operation, such as, number of rides, or dysfunction of specific HMD modules is transferred via cable or wireless data communication to the main server automatically or upon request in order to have a better business knowledge and maintenance abilities.

### Hygiene

The HMD is commercially designed for thousands of uses, in addition, the time to switch the HMD between riders is limited due to pressure of riders that are standing on line to get on the ride. In that case, there may be not enough time for sterilizing the HMD between uses. The hygiene problem worsens because the HMD is worn directly on people's heads, which means that there is over sensitivity by the riders for the HMD's sterility. A solution for this could be found by putting a buffer between the HMD and the rider's heads such as, hat of surgeons or a bath cap made of a thin nonwoven fabric. In that case, not only the HMD will be more sterile but also the time for switching HMD between riders will be significantly shortened. For the same reasons, the built-in speakers of the HMD should preferably be external (not located within) the rider's ear. In addition, the layer that is placed between the eyes and the HMD should be made out of a disposable, replaceable material as mentioned above. The single use elements (for head and eye cover) may be connected to the HMD with a mechanism such as Velcro type straps or clips.

### Safety

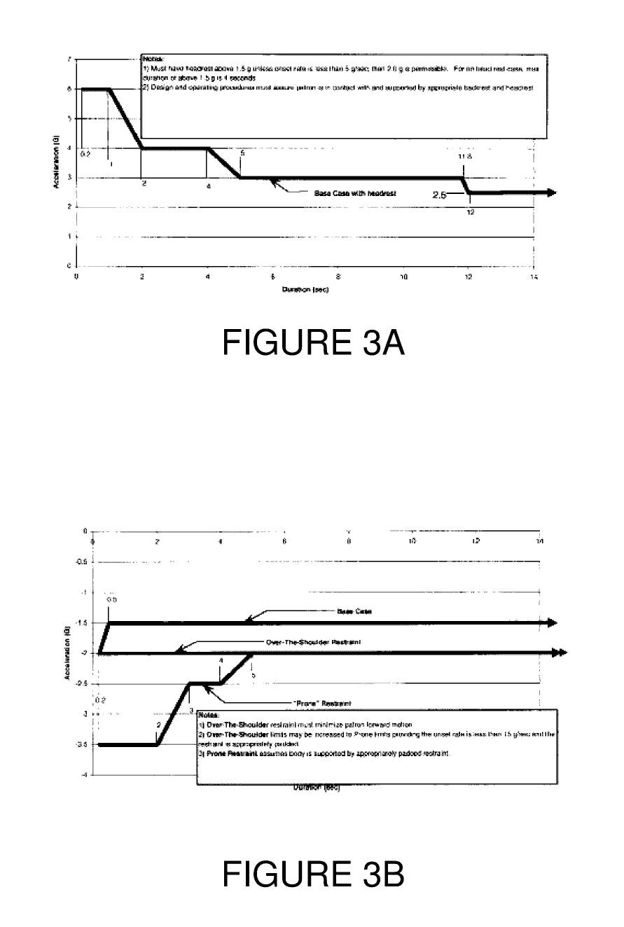

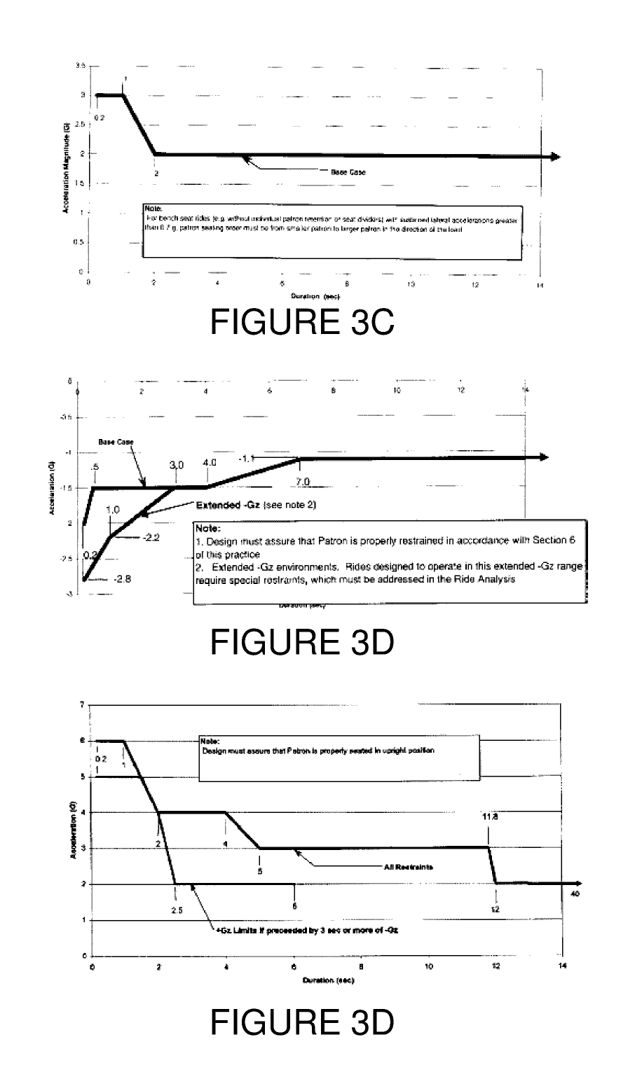

Refer now to FIGS. 3A to 3D, graphs of acceleration-duration limits. Safety of the rider wearing the HMD is an important consideration in the system design and implementation. In contrast to a user who uses an HMD in a regular environment, such as at the user's home, a HMD that is being used during a ride, and specifically during a ride at theme park, is subject to forces such as accelerations, sudden turns, or high gravitational force. Specifically, heavy biomechanical forces can act upon a riders head during a ride and can, in some cases, reach six G's (six times the normal force of gravity). Additional weight on the riders head under these forces could be dangerous. The HMD should preferably be weight limited according to biomechanical rules taking into account the size of the head, the gravity forces, the forces direction etc. Some of the calculations are based on the graphs of G-force limits according to ASTM F2291-14 are shown in the current figures. For example, with a roller coaster that might produce forces of 6G′y, the HMD weight should not exceed an average of 500 grams (depending on the riders head size). The HMD should be design so the center of mass relative to the head does not change significantly. In a case that there is a need to add more weight (capabilities, modules, sensors) to the HMD, the HMD can be divided into two parts: part on the rider's head and part in another location other than the rider's head, for example on the rider's arm, or on the roller-coaster car. The two parts can be connected with cable or wireless connectivity as known in the art. The part, which is not worn on the head, could consist of, for example, the battery, memory unit, processor, or the location sensors. This part can be laid on a place that is not interrupting the ride, in a safe location, such as the arm, hip, or integrated into the rider's seat.

The safety regulations in theme parks prohibit riders from carrying any separate belonging, such as, keys or sunglasses, during the ride. This safety regulation protects both the rider and other riders from being hurt by the rider's belonging that might fall on the other riders during the ride, and protecting the rider from instinctively trying to reach a falling belonging during the ride (and possibly causing the rider to fall).

In addition, there might be cases that riders become panicked because the displayed alternate reality (movie) is scary or because the rider's eyes are covered. When a rider is panicked, the rider might try to rip off the HMD. Removing the HMD during a ride could be dangerous for the rider and other riders. To avoid the rider removing the HMD during a ride, the HMD is built to insure that the HMD does not fall at any point during the ride (is secure during the entire ride). One technique for securing the HMD is having a double-strap (dual strap) closing system as the base on which the other parts of the HMD are built, for example the display. In this case, the HMD cannot fall from the rider's head during the ride and cannot be removed by the rider during the ride. To make sure the HMD is secure to the rider's head, the straps should be adjustable with, for example, a screw system as typically used with the helmet of construction workers. Since the chinstrap is used primarily for additional safety, the strap that goes under the head (chin) could be a little loose (that is, relatively looser than straps used for other activities) so the rider will not feel too much pressure on his face (as compared to conventional helmets and facemasks).

### Cooling, Passive Cooling

Another way to reduce weight of the HMD is to use a passive cooling system for the HMD's electronic devices. Instead of using a fan, for example, an airflow technique that uses the wind caused by the ride movement could be used to cool down the system.

### Method

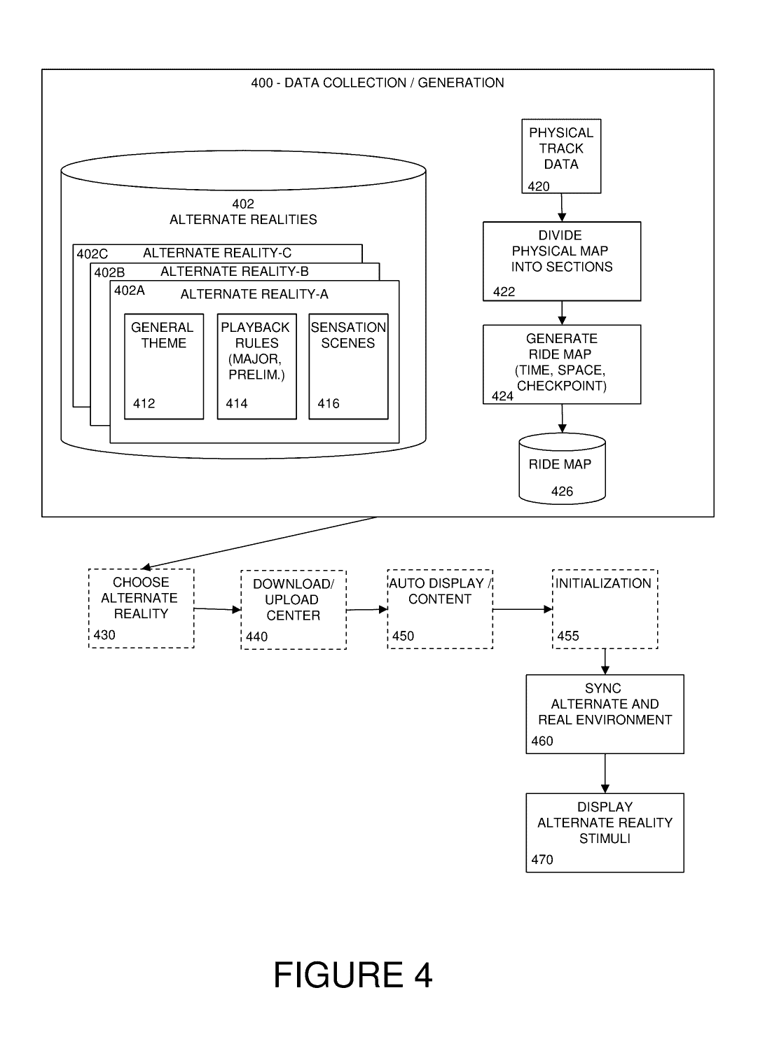

Refer now to FIG. 4, a sketch of a method to create and display an alternate reality. The system and corresponding method are designed to create an autonomous generic alternate environment display that may be applied to any moving object easily, and by that saving cost of creating adjusted virtual world for each ride attraction.

Data collection and generation 400 begins with alternate realities 402 and physical track data 420. Alternate realities 402 include exemplary alternate reality-A (for example fighting dragons), alternate reality-B (for example flying through space), and alternate reality-C (for example underwater adventure). Each alternate reality can be stored as an alternate reality file (data file), containing data sufficient for implementing a given alternate reality. An alternate reality (realities) 402 generally includes three components: a general theme (412), one or more sensation scenes (416), and playback rules (414). The specific components of an alternate reality 400 can vary, for example only including major playback rules and not preliminary playback rules (described below), or not including sensation scenes.

The general theme (412) is the background for the virtual environment. The general theme should bring the rider to a certain atmosphere. A general theme could be, for example, outer space, underwater world, or scary jungle. The items shown at the general theme are either static (for example a tree) or dynamic (for example, a falling star) but presented to the rider at a relatively far distance. Presenting objects at a far distance, does not require the system to locate highly accurately the rider's position, during ride's travel, in order to present the rider with the right scenery. This is because movement of the rider in space does not change significantly the angel of view relative to distanced objects.

A sensation scene (416) is a specific event that occurs during a certain point in time or space, supposed to supply the rider with a higher level of excitement, and needs to be synchronized accurately with the actual real world movement/location of the rider. A sensation scene could be, for example, a nearby asteroid that is about to collide with the rider, or a dragon that is about to prey on the rider. For intensive, realistic and exciting experience, the sensational scene can be played at a point on the track were the rider gets the feeling that the rider is just about to make a sharp maneuver to avoid the asteroid from hitting the rider or the dragon from eating the rider. Such illusion of sharp maneuver could happen if we place that scene just before a sharp decrease of the roller coaster track, for example.

The playback rules (414) are rules that describe ways to combine the sensation scene into the general theme. Major rules are playback rules that describe the trigger for activating a sensation scene. One major rule could be that when the rider makes a sharp turn to the right, the dragon is getting closer to the left side of the rider and trying to catch the rider, but fails. Another rule could be that 30 second after the beginning of the journey, an enemy's spaceship will shoot fire on the rider. Another rule could be that just when the rider is about to begin a sharp fall, an asteroid flies towards the rider and almost hits the rider. The rider has the illusion that the only reason the asteroids did not hit him is due to the immediate physical fall the rider experienced at the same moment. When a major rule is applied, there is typically, but not necessarily, a preliminary rule that must act before the major rule. The preliminary rule helps to prepare the atmosphere for the coming sensation scene peak in order that the rider will not sense a rapid change in the virtual world, but sense a flow, continuity of events, which make rider's illusion more reliable. One preliminary rule could be that before the enemy's space craft is shooting at the rider, a number of enemy's spacecraft are starting to gather in front of the rider and start getting closer more and more. If the major rule would apply alone, the rider would travel peacefully when a sudden action happened. In that case, the scene looks detached from the main storyboard and may harm the rider's experience. In another case, the alternate reality does want to provide sudden stimuli to surprise the rider, and the sensation scene is in the flow the events accordingly. A virtual world that is prepared using the method for this description is easier to apply to any roller coaster, as compared to conventional solutions.

Operating the system in a new theme park requires a set up procedure in which the physical path of a specific roller coaster needs to be obtained. In order to display a virtual world (alternate reality) on a specific roller coaster ride, the physical characteristics of the roller coaster track are needed. As mentioned above, data collection and generation 400 includes using physical track data 420. The physical characteristics of the roller coaster track are gathered to create the physical track data 420. Physical characteristics (track data 420) can include height, angle, gradient, loops, turns, curves, falls, accelerations, slowdowns, and velocity. Other examples of track data are track time data, such as the distance a rider travels at a given time interval. Track data measurement is done by recording data using sensors. All the physical characteristics are preferably recorded in a time-based format. The physical characteristics can be recorded with any electronic device that is equipped with appropriate sensors that can measure movements in space and time. Sensors, such as, gyroscope, accelerometer, magnetometer, inertial sensor, GPS, etc., can be used to record the track data 420. The physical data can also be recorded with a camera. Techniques for measuring the physical characteristics of a track are known, and one skilled in the art can choose a specific technique appropriate for the application. Note that as a typical implementation of the current embodiment for providing alternate reality to a user includes sufficient sensors for determining where the rider is in physical space (actual location) the system could alternatively be used in an “open” or “collection” mode to generate track data 420.

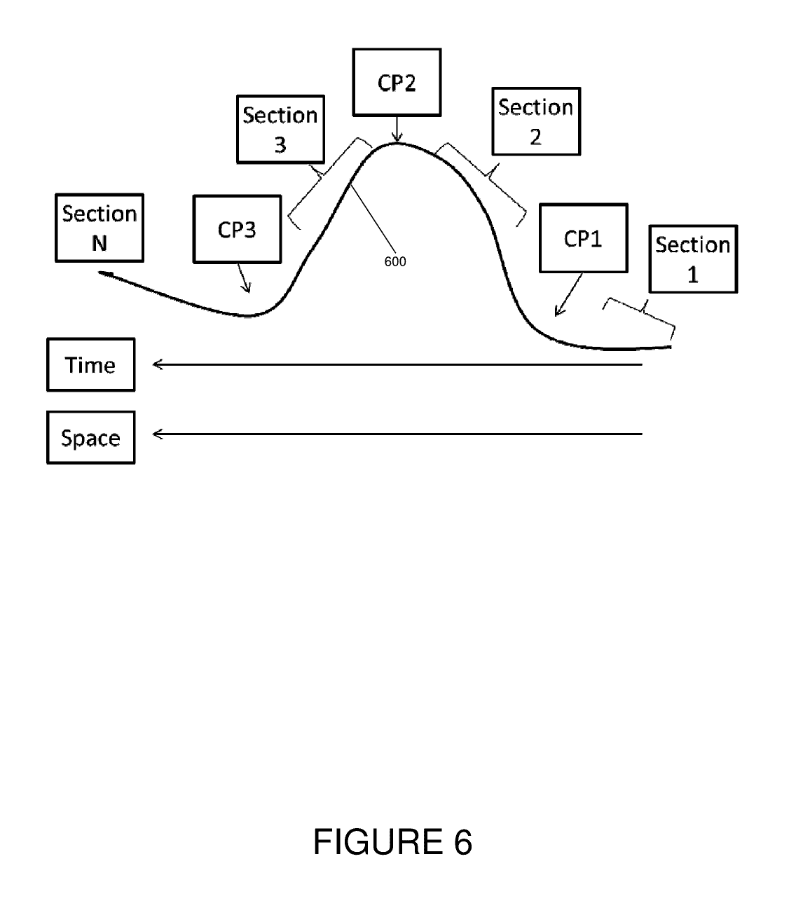

Refer now to FIG. 6, dividing 422 a physical map into separate sections. After gathering/collecting raw data describing the roller coaster physical track (track data 420), the raw data can be used as, or to generate a physical path (physical map) 600 of the roller coaster. The physical map 600 is typically based on time and space (shown as arrows in the current figure). Next the physical map 600 (raw data, raw track data 420) is divided into distinct sections. In the current figure, exemplary sections include section 1, section 2, section 3, and section N (where “N” indicates an integer number). Since the rider's relative location is determined by time and space based indicators from sensors, inaccuracy might accrue during the sensors on-line sampling of track data 420. For this reason, preferably, there are logical checkpoints along the track, which serve as a restart points and as absolute reference points. In the current exemplary figure, checkpoints include CP1, CP2, and CP3. As a result, having checkpoints increases the system's accuracy. Another use of checkpoints is to present special sensational scenes that require high positional accuracy. In this case, the special sensational scene can be placed at a checkpoint and activated with a major rule as described above in reference to major rules. Note that checkpoints are not physically implemented on the track. In other words, checkpoints do not require instrumenting (deploying hardware to) the track or car. Choosing a checkpoint can be done by algorithm and is based on analyzing the raw track data 420 or corresponding physical map, and by finding points along the track, that are “easier” for the sensors to sense than other points. Easier to notice points exist because at the easier to notice points the geography of the course is more distinguishable. Refer to the current figure that presents an example for checkpoints distribution. From the example, notice that checkpoints were chosen at places where dramatic directional changes happened, for example a turn point of more than 45 degrees or change in travel direction from increasing to decreasing in less than 2 seconds (CP2). The sections in between checkpoints can also be profiled, for example, a climbing, yawing, plain ride etc. While a preferred implementation is to use logical checkpoints derived from the physical map, the system can optionally use additional data such as from hardware installed in relation to the track to provide location and checkpoint information.

Next, from the analysis of the physical map a ride map (and optionally individual ride maps) 426 are generated 424. A ride map is a multi-layer map specific to a roller-coaster car on a track (obviously for a specific roller coaster). In general, a ride map is a description of a path of an object through physical space. A ride map can be viewed as the logical movement of an object (typically a user) based on a physical structure used for movement (such as a roller-coaster track). An individual ride map is a ride map that is additionally specific to a location of a given rider in the car 706. For example, a ride map of car 706 on track 708 can be used to generate individual ride maps for each of first user 700A and second user 700B. Individual ride maps are preferably generated ahead of time for each seat in a car on a roller coaster. Alternatively, a (general, for the entire car) ride map can be used by each HMD in the system, and knowledge of where a rider is sitting used to generate differential data and a corresponding individual ride map—either in real time during the ride, or preferably generated when the rider sits down/is strapped into the rider's seat in the car.

As an overview: In a roller coaster ride, a first rider who sits behind a second rider, experiences a different ride experience due to the first rider's location along the roller coaster being different from the second rider's location. For example, when a first row rider reaches a decline section a last row rider may still be in a prior climb section. As a result, the two riders will need to be provided different virtual environments. Obviously if two riders have selected the same alternate reality, then providing each of the two riders each with a different virtual environment refers to different times and space in the same selected virtual environment. In addition, the two riders feel a different acceleration when each of the two riders crosses the same point on the track. The above example demonstrates that in case the moving object is a multi-row object and we want to rely only on the time-based data, we should be able to measure the time-based data from a different row location along the moving object, and prepare a different ride map (individual ride map) for different row locations along the moving object. Alternatively, we can use one general ride map and adjust the general ride map during the ride. Alternatively, individual ride maps can be made for each seat instead of each row to increase data accuracy. Alternatively, a (one general) ride map can be adjusted according to physical laws that apply to the roller-coaster car and/or during a free fall situation.

As described above, an individual ride map is a multi-layer physical track map of a specific row (or seat) at a multi row moving object aimed to adjust the general track data (ride map) into a row based track data. The multi-layer map is a combination of the time-based and space-based data retrieved and the checkpoints described above. Knowing what kind of multi-layer map to use during the ride typically occurs after the ride begins. By detecting the ride profile at the beginning of the ride, the system obtains the approximate row where the rider seats and can choose the corresponding map. For example, traveling for 4 seconds at the initial surface indicates a ride profile of rider who sits in the back of the roller coaster. Alternatively, start climbing after five meters from beginning, indicates a ride profile of rider who sits in the front of the roller coaster.

Alternatively, rider location, and corresponding individual rider map, can be determined prior to the ride beginning. Techniques to determine static location of a rider when seated in the car include using external (external to the rider) broadcasts from known locations for triangulation by the system (HMD). For example placing multiple Bluetooth or Wi-Fi transmitters in the station. Augmented GPS is another possible technique. If the system includes a camera, then image processing can be used to determine a rider location. For example, a camera in the HMD can be used with landmarks in the station, or a camera in the station can track riders and broadcast the riders' locations to each rider's HMD. Alternatively, an indoor positioning system (IPS), as known in the art, can be used.

The rider chooses (430) the alternate reality to watch during the ride (unless the virtual world was already chosen for the rider by the operator). If the virtual reality's price is not included at the entrance ticket, the rider can pay directly at the cashiers or with a computer program, an app, website, or any other apparatus located at the park. Then, with one of these means of payment, the rider can choose the desired virtual world from a list of available worlds, or just pick a world from a list of worlds stored in the HMD memory. Note that choosing an alternate reality environment is an optional step, but for simplicity shown in the drawings as part of the typical method flow

After choosing 430 the desired alternate reality environment, the relevant alternate reality data file is optionally downloaded (440) into the ride's HMD (unless the data file is already stored in the system. The alternate data reality file can be stored in HMD memory or to a memory unit operationally connected to the HMD (for example, the memory unit in processing module 200). This can be done by connecting the HMD via a data cable or by wireless data connection from the main server or a local computer to the HMD. For using the wireless option, the rider should use one of the electronic input devices used for choosing the virtual world, enter the HMD id number, or scan the barcode printed on the HMD. Upon request, or automatically, a park operator can download the usage data from a certain HMD to a main computer. The data transfer could be done by a data cable or a wireless data connection. Data can include number of times a certain world has being played, what kind of worlds were played, errors in hardware etc. Note that downloading desired alternate reality environment is an optional step, but for simplicity shown in the drawings as part of the typical method flow.

Optional automatic displays 450 (such as audio and video contents) can be shown to a user. While a user is waiting in line, optionally the HMD can provide augmented reality display so the rider can see the line, and simultaneously access (by the rider) or be provided (by the operator) related and/or unrelated information. This situation may occur also while the rider is sitting in a roller coaster waiting for the beginning of the ride, or at the first moments of the ride. Information can include informational audio and/or video regarding the amusements park, history of the coaster, warning and preparatory messages (no strap-less shoes, no loose items in your pockets, no pacemakers, etc.), advertising for the amusement park, and/or 3rd party advertising. The system can recognize that the ride has not started yet by the pattern of movements of the rider. For safety reasons, this could only happen with a half-transparent or see-through HMD screens such that the rider will not clash with other people standing in the line or just fall because the rider's eyes were covered. In a case where the rider is already sitting in the rider's seat, having a half-transparent or see-through screen for applying the method above is not necessary. Note that this is an optional step, but for simplicity shown in the drawings as part of the typical method flow.

Optionally an initialization 455 can occur after an alternate reality has been chosen 430 but before the continuous synchronization 460 during a ride. System synchronization can begin automatically based on sensor feedback and detecting rider location and/or movement (as described elsewhere in this document). Alternatively, synchronization can be initiated, for example by the ride operator pressing a button and notifying the system that the ride is about to begin or has begun. Initialization 455 can include orientation of the HMD and virtual environment. Prior to the ride starting, or as the ride starts, the virtual environment should be oriented to the track (to the direction of the rider's movement). Orientation can be done based on the gaze data, sensors, the physical map, the real track absolute position, and/or other relevant data. Alternatively, the rider's virtual environment can be manually oriented to the rider's gaze by having the rider look to a given direction of the ride just before the ride begins. The environment position can be adjusted in advance (before the rider wears the system). For example, in the booth where the rider takes the HMD, the virtual environment can be uploaded/chosen and the HMD can be oriented to the track (as the location of the track is known relative to the location of the booth.

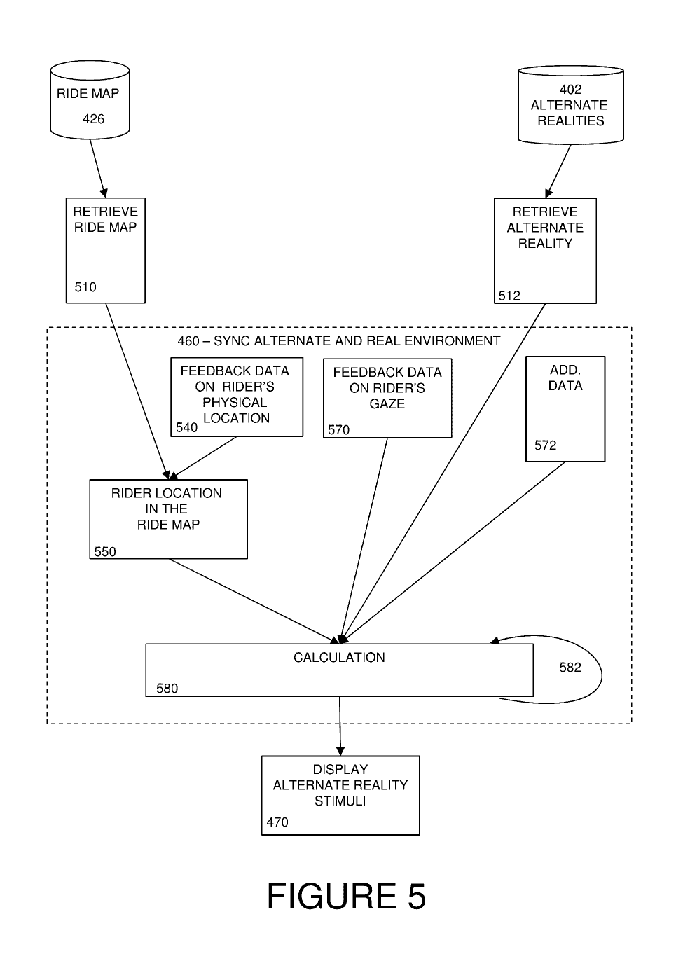

Synchronizing the alternate and real environments 460 is a significant feature of the current embodiment, and described in detail below in reference to FIG. 5. Presenting/changing a relevant view of an alternate reality scene is done in response to a movement of the rider wearing the HMD.

Displaying alternate reality stimuli 470 includes a way to provide relevant output of alternate world in relation to the position and movement of the individual riding on a moving object. The relevant output can include video, audio, and other sensory stimuli such as smell and tactile. Note that in the context of this document, for simplicity displaying the alternate reality includes output of other sensory stimuli. The display automatically begins and synchronizes during the ride time. This saves operation time and HMD development and maintenance costs. The auto display is done by recognizing the movement profile of the rider, as opposed to noises that are generated by a regular movement of the rider while being seated. For example, if the system recognizes a 3 seconds steady movement at a 10 km/hr and that is identical to the real physical path parameters the system holds in system/HMD memory, the system knows that the rider has started the ride, until then, the system play a general theme for the rider. Another way to begin automatically the display is to connect a wireless device to the operator button that begins the ride. The wireless device (such as a remote control or Bluetooth controller) is then pushed together with the operating button of the roller coaster and broadcast to the system (all the riders' devices) that the ride is beginning.

Refer now to FIG. 5, a flowchart of a method to synchronize alternate and real environments. A combination of the ride map 426, chosen alternate reality 402, feedback data on a rider's physical location 540, and feedback data on the rider's gaze 570 are used to determine a rider's location in the ride map 550, calculate what needs to be displayed and to then display the alternate reality stimuli 470. A typical system configuration includes a rider having both an HMD 702 and wearable add-ons 704. The HMD 702 is primarily used to determine the rider's gaze 570, while the wearable add-ons 704 are primarily used to determine the rider's physical location 540. Retrieval of a ride map 510 includes either retrieval of an individual ride map or generation of an individual ride map from a retrieved ride map. Retrieval of an alternate reality 512 is typically done prior to the ride starting, as described above.

Feedback data on rider's current (instantaneous, actual, real-time) physical location 540 within the operating travel path (physical path) of the roller coaster is continuously determined using the system's sensors 202 (accelerometers, gyroscopes, inertial, etc.). Typically, the rider's physical location 540 is primarily determined by wearable add-on 704 sensors worn by the rider. Optionally, the rider's physical location 540 can be determined using only the HMD 702 (without separate sensors on the rider—wearable add-ons 704), for example without the rider needing to wear a vest with add-on sensors to determine physical location of the rider. A feature of the current embodiment is that the physical location of the rider can be determined by the use of sensors worn by the rider, without the need for sensors deployed in other areas. In other words, the physical location of the rider can be determined using only sensors worn by the rider, and does not need external (to the person of the rider) sensors, for example on the car or track.

Determining rider location in the ride map 550 is done by synchronizing the riders individual ride map according to the rider's physical location. The common practice for synchronization between alternate reality and real world physical location is by using absolute location of the rider on the track, for example, placing sensors along the roller coaster track and connecting with the track sensors during the ride to decide were the roller coaster is located. This practice requires interaction with external infrastructure and is resource intensive. In contrast, a feature of the current system is being “self-contained” in that during the ride the system can determine data that the system needs and perform everything necessary to display the alternate reality stimuli.

The current embodiment uses a combination of three layers of location detection: time-based, space-based, and checkpoint, without the need for any additional external objects. The exact weight that is given to each layer is decided by predefined rules. For example, the determined location is decided by an average of the location given by the space and time based sensors. The methods of synchronizing the actual location of the rider (physical location) with the rider's location according to the ride map is done by applying an iterative procedure, in which the data received of the rider's physical location 540 is constantly compared to the map outline. For example, system's location detection sensors count 10 seconds from the beginning of movement, then 5 meters of slope at 30 degrees and then rotation of 10 degrees. Comparing the findings of the sensors to the map we have created, detects the place where such a pattern exists and the place is where the rider is located right now. To add more accuracy to the synchronization process, the checkpoint layer can additionally be used. Since sensors are electro-mechanical devices, the sensors might accumulate data errors because of environmental causes, or due to sudden stop of the roller coaster, for example. To lower the risk of data errors, we narrow the duration and distance that the sensors work in continuum and we standardize the sensor data according to the new checkpoints. For example, the sensors show that 53 seconds have passed from beginning until the third checkpoint. In our map, the third checkpoint should be arrived after 52 seconds. The error could have happed due to a sudden stop of the roller coaster during the ride, for example. After reaching the third checkpoint, the system standardizes the time-base data retrieved from the sensors to 52 seconds.

Feedback data on rider's gaze 570 is provided by the HMD's sensors including direction sensors, eye trackers, or any other wearable devices designate to track rider's direction of sight. Typically, feedback date on a rider's gaze is based on a combination of data on HMD orientation and eye tracking. Sensors on the HMD provide data as to how the HMD is oriented and eye trackers provide data on the specific direction of where the User is looking. In a case where the eye trackers are mounted on the HMD, the direction of the user's eyes is relative to the orientation of the HMD. The direction of the rider's gaze can be provided as “gaze data” or “rider gaze data” including sufficient information to determine the vector direction of where a rider is looking at a particular time. As described above in reference to initialization 455, prior to the tide starting, or as the ride starts, the virtual environment should be oriented to the track (to the direction of the rider's movement).

Calculation 580 is based on the provided inputs: typically, a combination of the rider location in the ride map 550, and retrieved 512 alternate reality 402 are used to determine a rider's location in the alternate reality. The rider's location in the alternate reality in combination with the position of the rider's head and direction of rider's eyes (provided as feedback data on riders gaze 570) are used to determine the alternate reality stimuli to be provided to the rider (or for simplicity displayed to the rider). As described above, the chosen alternate reality 402 includes playback rules 414 and other information. Optionally additional data 572 can be used for the calculation. Additional data can include sensing a rider action in a particular direction, for example using wearable feedback gloves as described below to calculate the user firing a weapon to blow up an approaching asteroid. As described above, orienting the alternate reality environment could be done using additional data such as the direction of the ride when the alternate reality is retrieved, 512 (in a case where the system was not calibrated [uncalibrated] beforehand). Calculation 580 generates one or more indicators or references that are used to determine which data set/piece of the alternate reality environment should be displayed. For example, if the rider's location is 50 meters from beginning and the rider looks to the right, the calculation should retrieve from the alternate reality data file the relevant alternate reality viewpoint where a yellow tree surrounded by a green jungle can be found. In addition, if a rule states that after 50 meters a dragon should come from the right side of the rider and touch him, the calculation should retrieve from data file the relevant alternate reality dragon scene and any other sensational elements related to the scene, such as the touch at the rider's shoulder. All of the feedback data and calculations are constantly supplied and repeatedly supplied during the ride. The calculation process constantly repeats (as indicated by 582), adjusting and updating the virtual world scenery display according to constantly receiving updated feedback data on rider's movement (physical location) 540, rider's gaze 570, and optionally additional data 572, for keeping the virtual world stimuli and effects seemingly flawless to the individual rider. The overall effect being the corners, the bumps, the acceleration, the g-forces, are all scaled to the alternate reality theme. For example, the theme dictates the space journey through an asteroid belt, and the maneuvering appears to be the exact movements felt during the ride.

Optional data can include feedback on the location of a rider's limbs, or props used by the rider. Props can include objects such as a gun strapped to the rider, joystick, steering wheel (attached to the car or the rider), or other user input devices. Sensors on the rider or on the prop can provide optional data on the direction, location, or use of the prop or other props. For example, the direction in which a rider's gun is pointed, or when a rider presses a firing button. This optional data can be used by the calculation 580 to provide the appropriate corresponding references from the alternate reality for alternate reality stimuli to be displayed 470.

Display alternate reality stimuli 470 is based on the calculation stage output (the calculated reference) that shows a relevant output of alternate reality environment in relation to the position and movement of the individual riding on a moving object. The relevant output includes video, audio, and other sensory such as smell and tactile as described above.

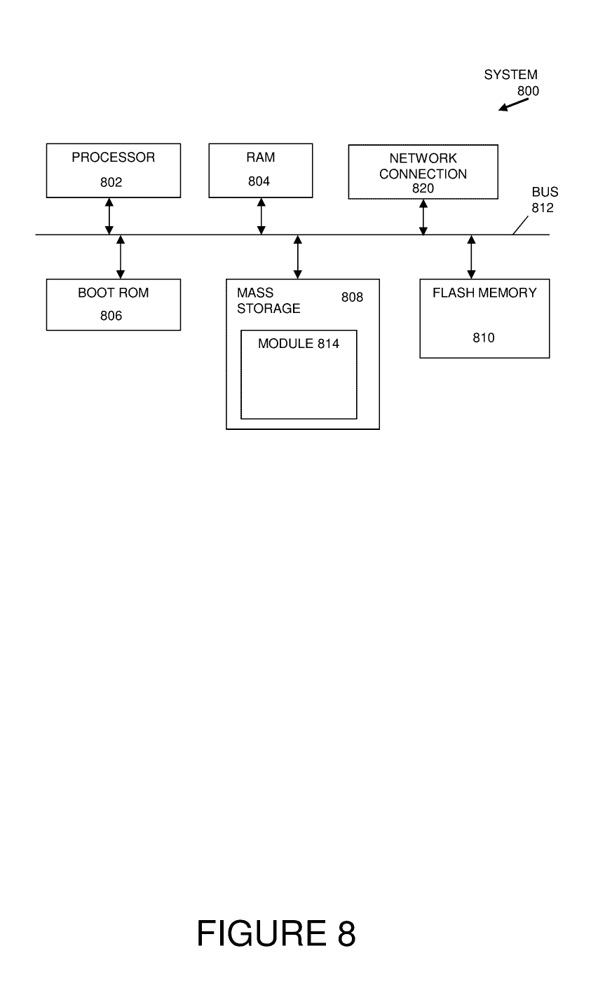

Refer now to FIG. 8 is a high-level partial block diagram of an exemplary system 800 configured to implement the processing module 200 of the present invention. System (processing system) 800 includes a processor 802 (one or more) and four exemplary memory devices: a RAM 804, a boot ROM 806, a mass storage device (hard disk) 808, and a flash memory 810, all communicating via a common bus 812. As is known in the art, processing and memory can include any computer readable medium storing software and/or firmware and/or any hardware element(s) including but not limited to field programmable logic array (FPLA) element(s), hard-wired logic element(s), field programmable gate array (FPGA) element(s), and application-specific integrated circuit (ASIC) element(s). Any instruction set architecture may be used in processor 802 including but not limited to reduced instruction set computer (RISC) architecture and/or complex instruction set computer (CISC) architecture. A module (processing module) 814 is shown on mass storage 808, but as will be obvious to one skilled in the art, could be located on any of the memory devices.

Mass storage device 808 is a non-limiting example of a non-transitory computer-readable storage medium bearing computer-readable code for implementing the alternate reality providing methodology described herein. Other examples of such computer-readable storage media include read-only memories such as CDs bearing such code.

System 800 may have an operating system stored on the memory devices, the ROM may include boot code for the system, and the processor may be configured for executing the boot code to load the operating system to RAM 804, executing the operating system to copy computer-readable code to RAM 804 and execute the code.

Network connection 820 provides communications to and from system 800. Typically, a single network connection provides one or more links, including virtual connections, to other devices on local and/or remote networks. Alternatively, system 800 can include more than one network connection (not shown), each network connection providing one or more links to other devices and/or networks.

System 800 can be implemented as a server or client respectively connected through a network to a client or server.

### Alternatives

In order to enable the rider to experience more than just passive watching at an alternate reality environment, the system can additionally include interactive input/output wearable devices, which aimed to increase the rider's level of excitement and participation in the alternate reality simulation. This can be done by changing the scene the rider is watching according to the rider's body gestures or by letting the rider to feel an alternate environment stimuli. For example, an asteroid that is about to crash into the rider is exploded according to the rider's hand movements. The rider could also feel some frictions of the asteroid after the explosion. The rider should wear (and if holding as with keyboard or joystick, there should be a safety belt to the held device) the interactive apparatuses in order to satisfy the safety needs of amusement rides, which prohibits any separate devices being held by the rider during the ride. Wearable devices could be, for example, gloves with contacts on the fingertips to be used as an input device, or other hand or legs tracking device like STEM of Sixense Entertainment, Inc. (Los Gatos, Calif. 95032, USA) products. Another wearable device could be a vest meshed with small vibrators, which gives the rider a feeling of touch when something hits the rider, such as the friction of the exploded asteroid from the previous example. In other words, a wearable add-on with haptic actuators to provide tactile stimulation to the user.

The physical (actual) location of the rider and corresponding location in the alternate reality environment in the above roller-coaster example are three-dimensional (3D). However, the system can be used in alternative environments such as a two-dimensional (2D) maze. In this case, the location tracking sensor 732 may only need to provide 2D location of the user 700 and the vision-tracking sensor 724 may need to provide either 2D or 3D data on the direction of gaze of the user's 700 eyes.

Note that a variety of implementations for modules and processing are possible, depending on the application. Modules are preferably implemented in software, but can also be implemented in hardware and firmware, on a single processor or distributed processors, at one or more locations. The above-described module functions can be combined and implemented as fewer modules or separated into sub-functions and implemented as a larger number of modules. Based on the above description, one skilled in the art will be able to design an implementation for a specific application.

1. A method for providing alternate reality to a user, comprising the steps of:
(a) providing a ride map describing a path of the user through physical space;
(b) providing an alternate reality file containing data sufficient for implementing a given alternate reality;
(c) providing a physical location of the user;
(d) providing gaze data of the user,
(e) determining a current location of the user in said ride map based on said ride map and said provided physical location; and
(f) calculating a reference, said calculating based on said current location of the user in the ride map, said provided gaze data, and the alternate reality, said reference indicating which parts of the alternate reality to provide to the user,
(g) wherein said physical location is provided based on sensors worn by the user.

2. The method of claim 1 wherein said physical location of the user is specific to the user and not to a vehicle of the user.

3. The method of claim 1 wherein said physical location of the user is provided only using sensors worn by the user.

4. The method of claim 1 wherein said sensors are of a head mounted device (HMD) worn by the user.

5. The method of claim 1 wherein a portion of said sensors are of a head mounted device (HMD) worn by the user and another portion of said sensors are of a wearable add-on worn by the user.

6. The method of claim 1 further including a step of: providing a portion of the alternate reality to the user based on said reference.

7. The method of claim 1 wherein the user is moving on a track, said track being a physical structure used for a known path of movement, and said determining a current location of the user is synchronized to the user's movement on said track.

8. The method of claim 1 wherein said ride map is an individual ride map based on the user's location in a moving vehicle on a path relative to a track.

9. The method of claim 1 wherein said ride map is a multi-layer map being a combination of time-based and space-based data describing the user's movement through physical space.

10. A system for providing alternate reality to a user, comprising:
(a) one or more sensors worn by the user; and
(b) a processing system containing one or more processors, said processing system being configured to:
(i) receive a ride map describing a path of the user through physical space;
(ii) receive an alternate reality file containing data sufficient for implementing a given alternate reality;
(iii) receive sensor data from said one or more sensors worn by the user;
(iv) derive a physical location of the user based on said sensor data;
(v) receive gaze data of the user,
(vi) determine a current location of the user in said ride map based on said ride map and said physical location; and
(vii) calculate a reference, said calculating based on said current location of the user in said ride map, said gaze data, and the alternate reality, said reference indicating which parts of the alternate reality to provide to the user.

11. The system of claim 10 wherein said processing system is worn by the user.

12. The system of claim 10 wherein said gaze data is provided by a head mounted display (HMD) worn by the user.

13. The system of claim 10 wherein said physical location of the user is specific to the user and not to a vehicle of the user.

14. The system of claim 10 wherein said physical location of the user is provided only using sensors worn by the user.

15. The system of claim 10 wherein said sensors are configure in a head mounted device (HMD) worn by the user.

16. The system of claim 10 wherein a portion of said sensors are configured in a head mounted device (HMD) worn by the user and another portion of said sensors are configured as wearable add-ons worn by the user.

17. The system of claim 10 wherein said processing system is further configured to: provide a portion of the alternate reality to the user based on said reference.

18. The system of claim 10 wherein the user is moving on a track, said track being a physical structure used for a known path of movement, and said determining a current location of the user is synchronized to the user's movement on said track.

19. The system of claim 10 wherein said ride map is an individual ride map based on the user's location in a moving vehicle on a path relative to a track.

20. The system of claim 10 wherein said ride map is a multi-layer map being a combination of time-based and space-based data describing the user's movement through physical space.

21. The system of claim 10 wherein the user is a rider on a roller coaster and an HMD is secured to the user's head via a dual-strap configuration including at least one strap under the user's chin and at least one strap over the user's head.

22. In the invention of claim 1 wherein the alternate reality is provided to a user via a head mounted display (HMD).

23. A non-transitory computer-readable storage medium having embedded thereon computer-readable code for providing alternate reality to a user, the computer-readable code comprising program code for:
(a) providing a ride map describing a path of the user through physical space;
(b) providing an alternate reality file containing data sufficient for implementing a given alternate reality;
(c) providing a physical location of the user;
(d) providing gaze data of the user;
(e) determining a current location of the user in said ride map based on said ride map and said provided physical location; and
(f) calculating a reference, said calculating based on said current location of the user in the ride map, said provided gaze data, and the alternate reality, said reference indicating which parts of the alternate reality to provide to the user,
(g) wherein said physical location is provided based on sensors worn by the user.

24. (canceled)

25. In the invention of claim 10 wherein the alternate reality is provided to a user via a head mounted display (HMD).
